(19) United States
(12) Patent Application Publication
(10) Pub. No.: US 2025/0349530 A1
(43) Pub. Date: Nov. 13, 2025

(54) Signal Processing Device, Signal Processing System, and Signal Processing Method

(71) Applicant: SHIMADZU CORPORATION, Kyoto-shi (JP)

(72) Inventors: Hiroko UEDA, Kyoto-shi (JP); Masaru NISHIGUCHI, Kyoto-shi (JP)

(21) Appl. No.: 19/198,986

(22) Filed: May 5, 2025

(30) Foreign Application Priority Data
May 9, 2024 (JP) 2024-076507

(51) Int. Cl. H01J 49/40

(52) U.S. Cl. CPC H01J 49/401

(57) ABSTRACT

The signal processing device applies signal-processing to one or more analysis data that are obtained through an analysis apparatus to generate a spectrum. The signal processing device comprises a memory that stores the one or more analysis data and a processor that applies signal-processing to the one or more analysis data. Each analysis data includes a plurality of data points. For each data point, the signal processing device calculates a first moving average of a first number of data points, calculates a second moving average of a second number of data points, the second number being larger than the first number, calculates a difference between the second and first moving averages, and determines the data point to be a signal if the difference is larger than a threshold value. The signal processing device generates for each analysis data a first spectrum including the data point determined to be the signal.

### CROSS REFERENCE TO RELATED APPLICATIONS

This nonprovisional application is based on Japanese Patent Application No. 2024-076507 filed on May 9, 2024 with the Japan Patent Office, the entire contents of which are hereby incorporated by reference.

### BACKGROUND OF THE INVENTION

### Field of the Invention

The present disclosure relates to a signal processing device, a signal processing system, and a signal processing method, and more specifically to a technique for applying signal processing to analysis data to generate a spectrum.

### Description of the Background Art

There is a demand for a better S/N ratio for a signal processing device that generates a spectrum from analysis data obtained through an analysis apparatus. “Resampling and deconvolution of linear time-of-flight records for enhanced protein profiling”, Malyarenko, Rapid Commun Mass Spectrom, 20(11), 1670-1678, 2006, doi: 10.1002/rcm.2496 discloses a result of applying a variety of types of filters to a signal obtained from a time-of-flight mass spectrometer (TOF-MS).

### SUMMARY OF THE INVENTION

However, appropriately removing noise from the analysis data requires designing an appropriate filter. For example, the TOF-MS has a possibility of a noise characteristic varying with the charge number and/or mass of the ion to be detected. Accordingly, designing the filter requires conducting a pre-analysis under a condition identical to that for a regular analysis and calculating a filter coefficient based on the result of the pre-analysis, which is cumbersome for the user.

The present disclosure has been made to solve such a problem, and an object of the present disclosure is to provide a signal processing device that improves an S/N ratio without designing a filter for each sample.

In one aspect of the present disclosure, a signal processing device applies signal processing to one or more analysis data that are obtained through an analysis apparatus to generate a spectrum. The signal processing device comprises a memory that stores the one or more analysis data and a processor that applies signal processing to the one or more analysis data. The one or more analysis data each include a plurality of data points. For each of the plurality of data points, the signal processing device is configured to: calculate a first moving average that is a moving average of a first number of data points; calculate a second moving average that is a moving average of a second number of data points, the second number being larger than the first number; calculate a difference between the second moving average and the first moving average; and determine the data point to be a signal when the difference is larger than a predetermined threshold value. The signal processing device is configured to generate for each of the one or more analysis data a first spectrum including the data point determined to be the signal.

In another aspect of the present disclosure, a signal processing method applies signal processing to one or more analysis data that are obtained through an analysis apparatus to generate a spectrum. The one or more analysis data each include a plurality of data points. The signal processing method comprises, for each of the plurality of data points: calculating a first moving average that is a moving average of a first number of data points; calculating a second moving average that is a moving average of a second number of data points, the second number being larger than the first number; calculating a difference between the second moving average and the first moving average; and determining the data point to be a signal if the difference is larger than a predetermined threshold value. The signal processing method further comprises generating for each of the one or more analysis data a spectrum including the data point determined to be the signal.

The foregoing and other objects, features, aspects and advantages of the present invention will become apparent from the following detailed description of the present invention understood when taken in conjunction with the accompanying drawings.

### BRIEF DESCRIPTION OF THE DRAWINGS

FIG. 1 schematically shows a configuration of a signal processing system according to an embodiment.

FIG. 2 is a flowchart of signal processing according to the first embodiment.

FIG. 3 is a flowchart of signal processing according to a second embodiment.

FIG. 4 represents a difference between moving averages in an example.

FIG. 5 represents a first spectrum in the example.

FIG. 6 represents a second spectrum in the example.

### DESCRIPTION OF THE PREFERRED EMBODIMENTS

Hereinafter, embodiments of the present disclosure will be described in detail with reference to the drawings. In the drawings, identical or equivalent components are identically denoted and will not be described repeatedly.

### Configuration of Signal Processing Device and Signal Processing System

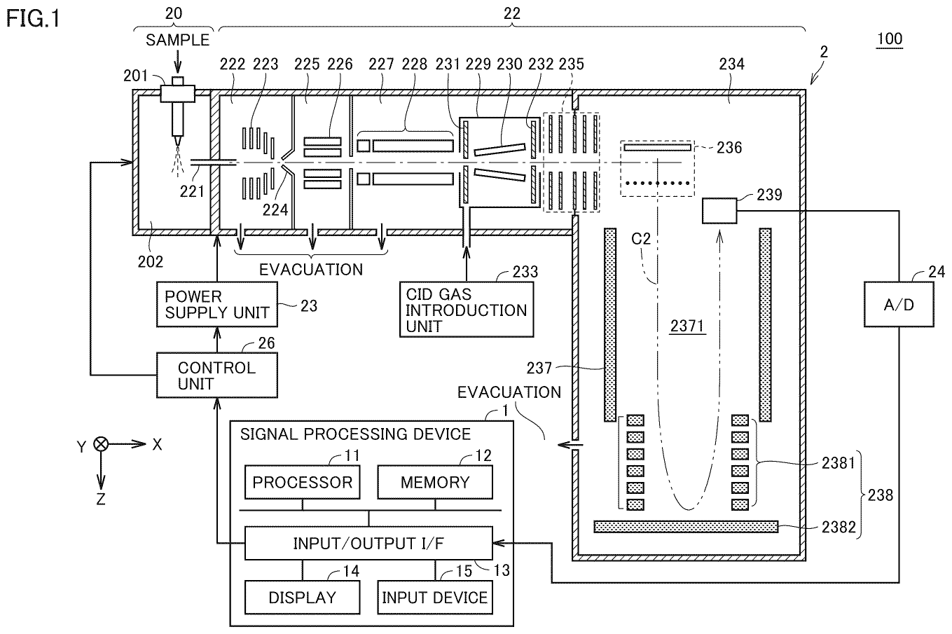

FIG. 1 schematically shows a configuration of a signal processing system 100 according to an embodiment. Signal processing system 100 comprises a signal processing device 1 and an analysis apparatus 2 according to the embodiment.

Signal processing device 1 applies signal processing to one or more analysis data that are obtained through analysis apparatus 2 to generate a spectrum. The spectrum is plotted for example along a first axis (e.g., an axis of abscissas) representing a physical quantity corresponding to a component included in a sample or a numerical value correlated with that physical quantity, and a second axis (e.g., an axis of ordinates) representing a intensity corresponding to a value along the axis of abscissas. Signal processing device 1 includes a processor 11, a memory 12, an input/output interface (I/F) 13, a display 14, and an input device 15.

Processor 11 applies signal processing to one or more analysis data that are obtained through analysis apparatus 2 (as will be described more specifically hereinafter). Processor 11 is typically a processing unit such as a central processing unit (CPU) or a micro processing unit (MPU). Processor 11 reads and executes a program stored in memory 12 to perform a variety of types of processing.

Memory 12 stores one or more analysis data obtained through analysis apparatus 2. Memory 12 is implemented as a storage device such as a ROM (read only memory), a RAM (random access memory), and an HDD (hard disk drive). The ROM can store a program executed by processor 11. The RAM can temporarily store data used during the execution of the program in processor 11, and can function as a temporary data memory used as a working area. The HDD is a nonvolatile storage device. A semiconductor memory device such as a flash memory may be employed in addition to or instead of the HDD. The program and/or the data may be stored in an external storage device accessible by processor 11.

Input/output I/F 13 is an interface for communicating a variety of types of data between processor 11 and an external device connected to input/output I/F 13. The external device includes a display 14, input device 15, and an analysis apparatus 2. Display 14 for example displays a result of processing by processor 11. Input device 15 is typically composed of a touch panel, a keyboard, a mouse, etc. Input device 15 receives an operation performed by a user for input to processor 11.

In one example, signal processing device 1 obtains one or more analysis data that are obtained through analysis apparatus 2 via input/output I/F 13. In another example, signal processing device 1 may obtain the analysis data via a storage medium having the analysis data stored therein, or may obtain the analysis data via a communication interface (I/F) (not shown).

Analysis apparatus 2 conducts an analysis to obtain one or more analysis data for generating a spectrum. Analysis apparatus 2 for example includes an introduction unit 20 that introduces a sample, an analysis unit 22 that analyzes the sample, an analog/digital (A/D) converter 24 that performs analog/digital (A/D) conversion of a detection signal obtained in analysis unit 22, and a control unit 26 that generally controls analysis apparatus 2.

In one example, analysis apparatus 2 is a time-of-flight mass spectrometer (TOF-MS). Hereinafter will be described a configuration in which analysis apparatus 2 is a time-of-flight mass spectrometer (TOF-MS).

Control unit 26 controls a variety of types of electrical components including electrodes disposed in analysis unit 22, and a power supply unit 23. Power supply unit 23 operates in response to a command received from control unit 26 to apply a predetermined voltage to each of the variety of types of electrical components in analysis unit 22. Control unit 26 for example includes a microcomputer.

Introduction unit 20 includes an electrospray ionization (ESI) source 201. ESI source 201 sprays a liquid sample into an ionization chamber 202 while applying an electric charge thereto. This ionizes a compound in the sample. Normally, ESI source 201 dispenses and thus introduces a single sample a plurality of times. As a result, analysis data equal in number to how many times the sample is introduced is obtained.

The technique of ionizing the compound is not limited thereto. For example, a method using a different ion source such as an atmospheric pressure chemical ion source may be employed. An ion source that ionizes a gaseous sample or a solid sample, rather than a liquid sample, may also be employed.

Ions generated in introduction unit 20 are analyzed in analysis unit 22 as follows. In analysis unit 22, the ions are moved along an ion optical axis C1, as described below.

Ions in ionization chamber 202 are initially sent to a first vacuum chamber 222 through a desolvation pipe 221 and converged by an ion guide 223. The ions converged by ion guide 223 are sent from first vacuum chamber 222 to a second vacuum chamber 225 via a skimmer 224. The ions sent to second vacuum chamber 225 are converged by an ion guide 226. The ions converged by ion guide 226 are sent from second vacuum chamber 225 to a third vacuum chamber 227.

In third vacuum chamber 227 are disposed a quadrupole mass filter 228 and a collision cell 229. In collision cell 229 are disposed a multipole ion guide 230, an inlet lens electrode 231, and an outlet lens electrode 232. Collision cell 229 functions as an ion trap that accumulates ions. Signal processing system 100 according to the present embodiment repeats accumulation of ions in the ion trap and ejection of ions from the ion trap for each sequence.

The ions sent to third vacuum chamber 227 are introduced into quadrupole mass filter 228. A voltage corresponding to ions to be analyzed is applied to quadrupole mass filter 228.

Therefore, of the ions introduced into quadrupole mass filter 228, only ions having a specific mass-to-charge ratio (m/z) responding to the applied voltage pass through quadrupole mass filter 228. The ions passing through quadrupole mass filter 228 are referred to as “precursor ions”. The precursor ions are introduced into collision cell 229. A collision induced dissociation (CID) gas introduction unit 233 supplies collision cell 229 with a CID gas. The precursor ions introduced into collision cell 229 are dissociated as they collide with the CID gas. As a result, a variety of types of product ions are produced in collision cell 229.

Product ions are temporarily accumulated in collision cell 229 by a function of the ion trap composed of ion guide 230, inlet lens electrode 231, and outlet lens electrode 232.

The ions accumulated in collision cell 229 are ejected from collision cell 229 toward a fourth vacuum chamber 234 as a single ion packet. An ion transporting optical system 235 composed of a plurality of electrodes is disposed between third vacuum chamber 227 and fourth vacuum chamber 234. The ions emitted from collision cell 229 are guided by ion transporting optical system 235 and thus introduced into fourth vacuum chamber 234.

In fourth vacuum chamber 234 are disposed an orthogonal acceleration unit 236, a flight tube 237, a reflector 238, and a detector 239. Reflector 238 includes a reflectron 2381 and a back plate 2382. In flight tube 237 is formed a flight space 2371 allowing ions to fly therethrough.

The ions are introduced into orthogonal acceleration unit 236 along the X axis and accelerated along the Z axis to enter flight space 2371. In flight space 2371, an electric field is formed to cause the ions to fly and turn around along a path C2. The ions fly from orthogonal acceleration unit 236 toward reflector 238 and make a U-turn by an effect of a reflection of the electric field provided by reflector 238 to re-enter flight space 2371. Thereafter, the ions reach detector 239.

Orthogonal acceleration unit 236 accelerates ions having smaller m/z faster. Thus, an ion's time of flight (TOF) from the ion trap through orthogonal acceleration unit 236 to detector 239 varies with the ion's m/z. Thus, ions are separated according to m/z. Detector 239 detects ions in the order of m/z. Thus, detector 239 generates an ion intensity signal as a detection signal. Detector 239 is connected to A/D converter 24.

A/D converter 24 receives the ion intensity signal from detector 239 of analysis unit 22, subjects the received ion intensity signal to A/D conversion, and transmits the A/D converted signal to signal processing device 1.

Signal processing device 1 receives the ion intensity signal digitized by A/D converter 24 and uses the digitized ion intensity signal to generate “one-shot data” indicating a relationship between ion intensity and time of flight (TOF). The one-shot data corresponds to one example of “analysis data”.

Signal processing system 100 repeats a plurality of times a sequence of generating ions in introduction unit 20, emitting ions accumulated in collision cell 229, and detecting ions by detector 239 in accordance with m/z. As a result, “one-shot data” equal in number to how many times the sequence is performed are generated. Each sequence is performed with a single TOF range and a single sampling interval. A plurality of one-shot data corresponds to one example of “a plurality of analysis data obtained by analyzing a single sample a plurality of times”.

Signal processing device 1 uses the plurality of generated one-shot data to generate a TOF spectrum. The TOF spectrum corresponds to one example of a “spectrum”. The TOF spectrum is plotted along a first axis (e.g., an axis of abscissas) representing a TOF correlating to an m/z of an ion derived from a sample and a second axis (e.g., an axis of ordinates) representing intensity corresponding to TOF.

More specifically, signal processing device 1 generates a spectrum with a better S/N ratio in a signal processing method according to an embodiment described hereinafter. Throughout the present specification, a signal refers to a signal component reflecting a component to be detected, and noise refers to a signal component which does not reflect the component to be detected (for example, a signal component generated in signal processing from detector 239 to signal processing device 1). The “signal” and the “noise” may also be referred to as a “signal component” and a “noise component”, respectively, by those skilled in the art.

In another example, analysis apparatus 2 is a mass spectrometer rather than a TOF-MS. In that case, signal processing device 1 generates a mass spectrum rather than a TOF spectrum.

In still another example, analysis apparatus 2 includes a chromatograph and/or a spectroscope. In that case, signal processing device 1 generates a spectrum depending on the type of analysis apparatus 2.

### Conventional Signal Processing Device

Conventionally, when analysis data obtained through an analysis apparatus such as a TOF-MS is subjected to signal processing, a detection signal received from an A/D converter is accumulated for an increased period of time, filtering is applied to remove noise, and so on to obtain a better S/N ratio.

Generally, assuming that the detection signal is an impulse response signal, the filtering requires preprocessing such as identifying a signal and noise and determining a filter coefficient. For example, filtering for the TOF-MS requires assuming an ion intensity signal of one-shot data as an impulse response signal, identifying a signal and noise, and determining a filter coefficient.

Typical factors for noise in analysis data include ringing derived from an electrical system in an analysis apparatus, a detector's characteristics, and a quantization error in A/D conversion. In addition, when a noise characteristic may vary with a characteristic of a component to be detected, as it does when a TOF-MS is used, it is also necessary to consider an effect thereof. For example, one-shot data obtained through a TOF-MS may present a noise characteristic varying with the charge number and/or mass of the ion to be detected.

Accordingly, filtering analysis data obtained through an analysis apparatus such as a TOF-MS requires conducting a pre-analysis in advance under a condition identical to that for a regular analysis, and setting a filter coefficient based on a result of the pre-analysis. On the other hand, when a filter coefficient which is not based on the result of the pre-analysis is employed, there is a possibility of failing to reduce noise with respect to analysis data of the regular analysis, reducing a intensity of a signal, etc.

In addition, when noise spreads in a wide range from a low frequency range to a high frequency range with respect to a sampling rate of an A/D converter, a filter coefficient capable of effectively removing/reducing noise may not be determined.

Thus, filtering analysis data obtained through an analysis apparatus such as a TOF-MS is challenging in that it is cumbersome to set a filter coefficient in advance, a filter coefficient cannot be determined, and so on.

In view of the above circumstances, the signal processing according to the embodiment provides a spectrum with a better S/N ratio without designing a filter for each sample.

### First Embodiment

Signal processing according to a first embodiment is used when a single spectrum is generated from single analysis data.

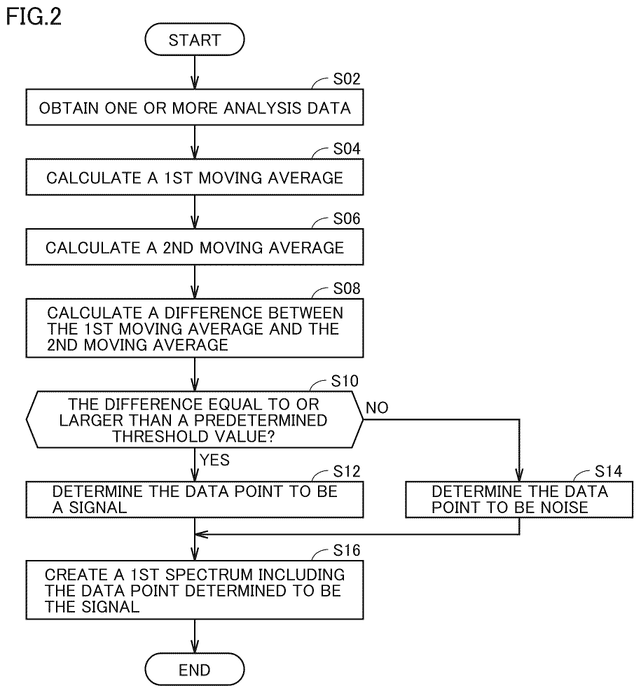

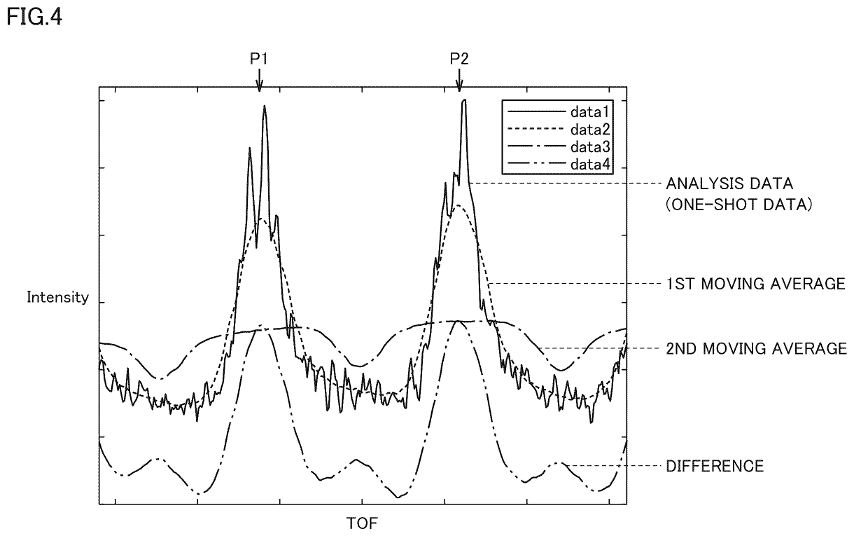

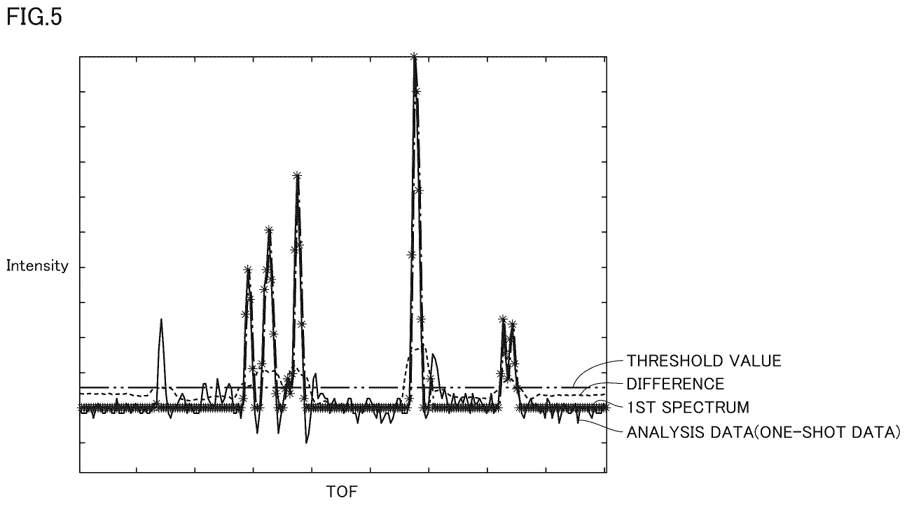

FIG. 2 is a flowchart of the signal processing according to the first embodiment. Each step (hereinafter also simply indicated as “S”) in FIG. 2 is performed by processor 11 of signal processing device 1. Hereinafter, the FIG. 2 process will be described with reference to a part of an example in which the signal processing according to the first embodiment is applied to a TOF-MS (see FIGS. 4 to 5).

In S02, processor 11 obtains one or more analysis data (see “analysis data” in FIG. 4). The one or more analysis data each include a plurality of data points.

In one example of S02, processor 11 obtains one or more one-shot data obtained through a TOF-MS. The one or more one-shot data each include a plurality of data points. The plurality of data points are each defined by a predetermined TOF and an ion intensity detected for the TOF.

In S04, processor 11 calculates for each of the plurality of data points a first moving average that is a moving average of a first number of data points (see “first moving average” in FIG. 4).

In S06, processor 11 calculates for each of the plurality of data points a second moving average that is a moving average of a second number of data points (see “second moving average” in FIG. 4). The second number is larger than the first number. The second number is, for example, twice or more times and 20 or less times the first number, and more specifically, 5 or more times and 15 or less times the first number, although it is not limited thereto. In an example described below, the second number is ten times the first number.

In S08, processor 11 calculates for each of the plurality of data points a difference between the second moving average and the first moving average (see “difference” in FIG. 4).

In S10, processor 11 determines whether the difference is equal to or larger than a predetermined threshold value. In one example, the predetermined threshold value is calculated based on an average value of a predetermined number of data points obtained after the analysis is started, and a standard deviation of the obtained, predetermined number of data points. For example, the predetermined threshold value is the average value plus several times the standard deviation. A predetermined number after an analysis is started is a number of data points obtained for a predetermined period of time for which no sample is detected after the analysis is started. It is believed that the predetermined number of data points obtained for the predetermined period of time do not include a signal derived from a sample and only include a value that serves as a base for the analysis data (or a baseline after the analysis is started), and noise. Thus, the predetermined threshold value can be the value that serves as the base, and a value with noise variation considered. A data point with the difference departing form the value that serves as the base by the noise variation or larger can be determined to be a signal.

Whether the difference is equal to or larger than the predetermined threshold value is determined for each of the plurality of data points, and if so (YES in S10), then in S12, processor 11 determines the data point to be a signal (see FIG. 5).

If the difference is smaller than the predetermined threshold value for the data point (NO in S10), processor 11 determines the data point to be noise in S14.

In S16, processor 11 generates for each of the one or more analysis data a first spectrum including the data point determined to be the signal, and ends the process.

In the FIG. 2 process, the first number and the second number are determined depending on a characteristic of a signal in analysis data of signal processing system 100, and a characteristic of noise. The first number and the second number are determined in advance for each signal processing system 100, for example.

The first number is determined to have a value to reduce (or smooth) an effect of a high-frequency component by averaging the analysis data, for example. More specifically, for example, the first number is determined to be equal to or larger than a number of data points corresponding to a single wavelength of the high-frequency component. It is believed that the high-frequency component for example reflects noise of a high frequency generated in signal processing from detector 239 to signal processing device 1. This configuration can mitigate an effect of the noise of the high frequency in S04.

The first number has a value determined based on a characteristic of signal processing system 100, and is for example 10 in the example shown in FIG. 4. In other words, in the example shown in FIG. 4, the first moving average is a moving average of 10 data points.

The second number is set to take an average value for a range larger than the first number. The second number thus set allows a local baseline to be calculated by the second moving average. This allows a signal to be emphasized in a plot obtained by subtracting the second moving average from the first moving average.

More specifically, the second number is set while its balance with the first number is considered. For example, the second number is determined to be such a value that a peak derived from a component to be detected (i.e., a signal) is detectable from the difference between the first moving average and the second moving average as calculated in S08. For example, when the second number is equal in extent to the first number, the first moving average and the second moving average substantially match, and it is difficult to detect a signal in the difference. On the other hand, when the second number is set to be excessively larger than the first number, the second moving average approaches an average value in intensity of the entire analysis data, and a signal smaller than the average value will be undetectable. Furthermore, a case in which the baseline for the analysis data changes is also unhandleable. The second number has a value determined based on a characteristic of signal processing system 100, and in the FIG. 4 example the second number is 10.0 times the first number, i.e., 100. In other words, in the FIG. 4 example, the second moving average is a moving average of 100 data points.

In S10 to S14, a data point for which the difference between the first moving average and the second moving average is equal to or larger than the predetermined threshold value is determined to be a signal and any other data point is determined to be noise, so that, of the data points in the analysis data, the data point determined to be the signal can remain and the data point determined to be the noise can be removed. Specifically, for example, processor 11 generates a spectrum in which a data point determined to be a signal is unchanged in intensity and a data point determined to be noise is zeroed in intensity. This allows corrected data, or the first spectrum, with a S/N ratio better than that of original data, or the analysis data.

### Second Embodiment

Signal processing according to a second embodiment is mainly used when a single spectrum is generated from a plurality of analysis data obtained by analyzing a single sample a plurality of times.

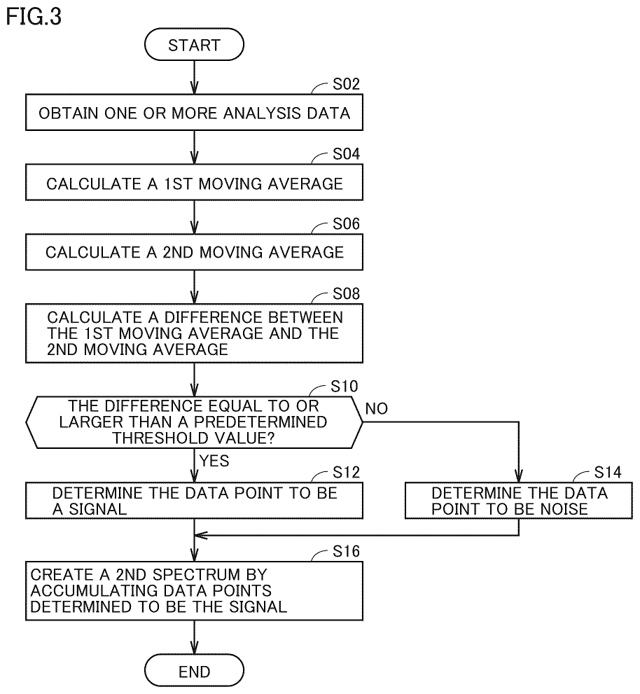

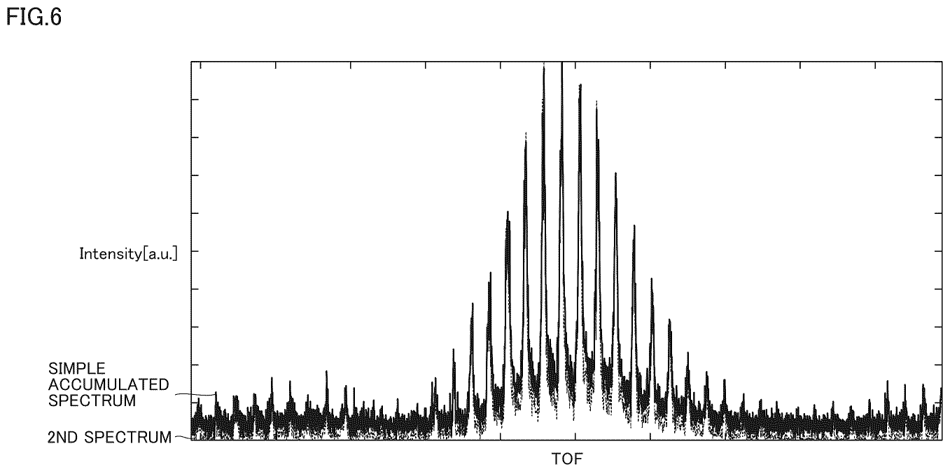

FIG. 3 is a flowchart of the signal processing according to the second embodiment. Each step in FIG. 3 is performed by processor 11 of signal processing device 1. Hereinafter, the FIG. 3 process will be described with reference to a part of an example in which the first embodiment is applied to a TOF-MS (see FIG. 6).

With reference to FIG. 3, in S02, processor 11 obtains a plurality of analysis data obtained by analyzing a single sample a plurality of times. The plurality of analysis data each include a plurality of data points.

In one example of S02, processor 11 obtains a plurality of one-shot data obtained by subjecting the single sample to a TOF-MS analysis the plurality of times.

Steps S04 to S14 in FIG. 3 correspond to steps S02 to S14 in FIG. 2. In S16, processor 11 generates a second spectrum by accumulating those data points of each of the plurality of analysis data which are determined to be a signal. In other words, the second spectrum is an accumulated spectrum obtained by accumulating signals of the plurality of analysis data (see “second spectrum” in FIG. 6).

Note that signal processing device 1 may perform S02 to S14 whenever each of the plurality of analysis data is obtained, or may perform S02 to S14 for each of the analysis data after the plurality of analysis data is all obtained. In either case, the FIG. 3 process does not require the user's operation and is implemented only through processing internal to signal processing device 1.

According to the FIG. 3 process, of each of a plurality of analysis data, only a data point determined to be a signal has its intensity accumulated, and a signal determined to be noise does not have its intensity accumulated. Specifically, for example, for each of the plurality of analysis data, processor 11 leaves a data point determined to be a signal unchanged in intensity and zeros a data point determined to be noise in intensity, and accumulates the signal in each of the plurality of analysis data in intensity to generate the second spectrum. Thus, the second spectrum has an S/N ratio better than that of a simple accumulated spectrum obtained by simply accumulating each of the plurality of analysis data (see FIG. 6).

### EXAMPLES

FIGS. 4 to 6 represent a result of the signal processing according to the embodiments in an example in stages.

In the example, the signal processing according to the embodiments was applied to analysis data obtained by analyzing myoglobin (molecular weight: 17,000 Da) in a TOF-MS with the ESI method used for ionization.

FIG. 4 represents a difference between moving averages in the example. In the FIG. 4 example, a moving average of data at 10 points was calculated as the first moving average. Then, a moving average of data at 100 points was calculated as the second moving average. Referring to FIG. 4, a high-frequency component superimposed on a major peak (peaks indicated by reference characters P1 and P2) of uncorrected data or one-shot data is removed in the difference between the first moving average and the second moving average.

FIG. 5 represents a first spectrum in the example. In the FIG. 5 example, as the threshold value is used a value obtained by adding together an average value of the first 100 points of one-shot data and a value of 10 times a standard deviation of the first 100 points of the one-shot data. By using this threshold value, a range along the axis of abscissas that has a difference value equal to or larger than the threshold value can be determined to be a signal range, and a range along the axis of abscissas other than the signal range can be determined to be a noise range. Then, a first spectrum can be generated in which a intensity of the one-shot data corresponding to the signal range is unchanged and a intensity of the one-shot data corresponding to the noise range is replaced with 0. Referring to FIG. 5, the first spectrum holds a intensity of a peak indicating a intensity significantly larger than a surrounding intensity and hence considered to correspond to a signal, and has removed therefrom a peak indicating a intensity slightly larger than a surrounding intensity and hence considered to correspond to noise.

FIG. 6 represents a second spectrum in an example. The second spectrum shown in FIG. 6 (data indicated in FIG. 6 by a solid line) is generated by accumulating a plurality of first spectra obtained by correcting a plurality of one-shot data obtained by repeatedly analyzing a single sample. When the second spectrum is compared with a conventional, simple accumulated spectrum obtained by simply accumulating all one-shot data without correcting the data (i.e., data represented in FIG. 6 by a dotted line), the second spectrum has a reduced value for an interpeak trough corresponding to noise. The one-shot data in the signal range has its intensity held in the corrected, first spectrum as well, and the second spectrum, obtained by accumulating first spectra, also has the intensity substantially equally to that in the conventional, simple accumulated spectrum. Thus, the signal processing according to the present embodiment that reduces noise while holding intensity of a signal allows the second spectrum to have an S/N ratio better than that of the simple accumulated spectrum by about 1.7 times. Note that in the FIG. 6 example, the S/N ratio is calculated as a ratio in intensity of a maximum peak of each spectrum to a trough adjacent to the maximum peak.

As indicated above, signal processing device 1 and the signal processing method according to each of the first and second embodiments can provide a signal processing device that improves an S/N ratio without designing a filter for each sample.

In particular, when analysis apparatus 2 is a TOF-MS, noise may affect the charge number and/or mass of the ion to be detected, however, a TOF spectrum in which noise of one-shot data is removed and only a signal of the data is accumulated can be obtained without performing a pre-analysis and designing a filter coefficient.

Even when analysis apparatus 2 is a mass spectroscope rather than the TOF-MS, a chromatograph, and/or a spectroscope, a variety of types of spectra with a better S/N ratio can be similarly obtained without designing a filter.

### Aspects

It will be understood by those skilled in the art that the plurality of exemplary embodiments described above are specific examples of the following aspects.

(Clause 1) In one aspect, a signal processing device applies signal processing to one or more analysis data that are obtained through an analysis apparatus to generate a spectrum. The signal processing device comprises a memory that stores the one or more analysis data, and a processor that applies signal processing to the one or more analysis data. The one or more analysis data each include a plurality of data points. For each of the plurality of data points, the signal processing device is configured to: calculate a first moving average that is a moving average of a first number of data points; calculate a second moving average that is a moving average of a second number of data points, the second number being larger than the first number; calculate a difference between the second moving average and the first moving average; and determine the data point to be a signal if the difference is larger than a predetermined threshold value. For each of the one or more analysis data, the signal processing device is configured to generate a first spectrum including the data point determined to be the signal.

The signal processing device according to clause 1 can be a signal processing device that improves an S/N ratio without designing a filter for each sample.

(Clause 2) The signal processing device according to clause 1, wherein the one or more analysis data include a plurality of analysis data. The plurality of analysis data are obtained by analyzing a single sample a plurality of times. The signal processing device is configured to generate a second spectrum by accumulating a data point of the plurality of analysis data that is determined to be the signal.

The signal processing device according to clause 2 can accumulate a signal in each of the plurality of analysis data in intensity to generate the second spectrum. Thus, the second spectrum has an S/N ratio better than that of a simple accumulated spectrum obtained by simply accumulating each of the plurality of analysis data.

(Clause 3) The signal processing device according to clause 1 or 2, wherein the predetermined threshold value is calculated based on an average value of a predetermined number of data points of the plurality of data points after an analysis is started, and a standard deviation of the predetermined number of data points.

The signal processing device according to clause 3 allows the predetermined threshold value to be a value that serves as a base for the analysis data, and a value with noise variation considered.

(Clause 4) The signal processing device according to any one of clauses 1 to 3, wherein the second number is equal to or larger than twice or more times and 20 or less times the first number.

The signal processing device according to clause 4 allows the second number to be set based on the first number.

(Clause 5) The signal processing device according to any one of clauses 1 to 4, wherein the analysis apparatus includes a time-of-flight mass spectrometer (TOF-MS).

While noise may affect the charge number and/or mass of the ion to be detected, the signal processing device according to clause 5 can provide a TOF spectrum in which noise of one-shot data is removed and only a signal of the data is accumulated, without performing a pre-analysis and designing a filter coefficient.

(Clause 6) The signal processing device according to any one of clauses 1 to 4, wherein the analysis apparatus includes a mass spectroscope rather than a TOF-MS, a chromatograph, and/or a spectroscope.

The signal processing device according to clause 6 can also provide a variety of types of spectra with a better S/N ratio without designing a filter.

(Clause 7) A signal processing system comprising the analysis apparatus and the signal processing device according to any one of clauses 1 to 6.

The signal processing system according to clause 7 allows a signal processing device to be provided to improve an S/N ratio without designing a filter for each sample.

(Clause 8) In another aspect, a signal processing method applies signal processing to one or more analysis data that are obtained through an analysis apparatus to generate a spectrum. The one or more analysis data each include a plurality of data points. The method comprises, for each of the plurality of data points: calculating a first moving average that is a moving average of a first number of data points; calculating a second moving average that is a moving average of a second number of data points, the second number being larger than the first number; calculating a difference between the second moving average and the first moving average; and determining the data point to be a signal if the difference is larger than a predetermined threshold value. The method further comprises, for each of the one or more analysis data, generating a spectrum including the data point determined to be the signal.

The signal processing method according to clause 8 allows a signal processing device to improve an S/N ratio without designing a filter for each sample.

While the embodiments of the present invention have been described, it should be understood that the embodiments disclosed herein are illustrative and non-restrictive in any respect. The scope of the present invention is defined by the terms of the claims and intended to encompass any modification falling within the meaning and scope equivalent to the terms of the claims.

What is claimed is:

1. A signal processing device that applies signal processing to one or more analysis data that are obtained through an analysis apparatus to generate a spectrum, the signal processing device comprising:
a memory that stores the one or more analysis data; and
a processor that applies signal processing to the one or more analysis data, wherein
the one or more analysis data each include a plurality of data points, and
the signal processing device is configured to:
for each of the plurality of data points,
calculate a first moving average that is a moving average of a first number of data points;
calculate a second moving average that is a moving average of a second number of data points, the second number being larger than the first number;
calculate a difference between the second moving average and the first moving average;
determine the data point to be a signal if the difference is larger than a predetermined threshold value; and
for each of the one or more analysis data, generate a first spectrum including the data point determined to be the signal.

2. The signal processing device according to claim 1, wherein
the one or more analysis data include a plurality of analysis data,
the plurality of analysis data are obtained by analyzing a single sample a plurality of times, and
the signal processing device is configured to generate a second spectrum by accumulating a data point of the plurality of analysis data that is determined to be the signal.

3. The signal processing device according to claim 1, wherein the predetermined threshold value is calculated based on an average value of a predetermined number of data points of the plurality of data points after an analysis is started, and a standard deviation of the predetermined number of data points.

4. The signal processing device according to claim 1, wherein the second number is equal to or larger than twice or more times and 20 or less times the first number.

5. The signal processing device according to claim 1, wherein the analysis apparatus includes a time-of-flight mass spectrometer (TOF-MS).

6. The signal processing device according to claim 1, wherein the analysis apparatus includes a mass spectroscope rather than a TOF-MS, a chromatograph, and/or a spectroscope.

7. A signal processing system comprising the analysis apparatus and the signal processing device according to claim 1.

8. A signal processing method for applying signal processing to one or more analysis data that are obtained through an analysis apparatus to generate a spectrum,
the one or more analysis data each including a plurality of data points,
the method comprising:
for each of the plurality of data points,
calculating a first moving average that is a moving average of a first number of data points;
calculating a second moving average that is a moving average of a second number of data points, the second number being larger than the first number;
calculating a difference between the second moving average and the first moving average;
determining the data point to be a signal if the difference is larger than a predetermined threshold value; and
for each of the one or more analysis data, generating a spectrum including the data point determined to be the signal.
